(19) United States
(12) Patent Application Publication
(10) Pub. No.: US 2013/0299631 A1
(43) Pub. Date: Nov. 14, 2013

(54) DRIVE SCREW ASSEMBLY AND LANDING GEAR ASSEMBLY WITH SAME

(71) Applicant: Miles Tucker, Cheltenham (GB)

(72) Inventor: Miles Tucker, Cheltenham (GB)

(73) Assignee: GE AVIATION SYSTEMS LIMITED, Cheltenham (GB)

(21) Appl. No.: 13/609,860

(22) Filed: Sep. 11, 2012

(30) Foreign Application Priority Data
May 10, 2012 (GB) 12081790

(51) Int. Cl. B64C 25/26; B64C 25/20; F16H 19/02

(52) U.S. Cl. 244/102 R; 74/424.71

(57) ABSTRACT

A landing gear assembly includes a leg that may be rotated between retracted and extended positions, a link assembly, and a drive screw assembly. The drive screw assembly includes a casing, a piston slidably coupled to the casing for reciprocation relative to the casing and a portion mounted to the link assembly and where the drive screw assembly is capable of locking and unlocking.

### CROSS-REFERENCE TO RELATED APPLICATIONS

This application claims priority under 35 U.S.C. §119 to British Patent Application No. 12081790, filed May 10, 2012, the disclosure of which is incorporated herein by reference.

### BACKGROUND OF THE INVENTION

In conventional aircraft, retraction and extension of landing gear is usually accomplished by the use of a linear actuator. Conventional linear actuators may be automatically or manually driven from a rotary source. The actuator includes a mechanism to convert the rotary motion from the rotary source to a linear output motion to translate an external load, which may be accomplished by extending a ram. The actuator may have a lock mechanism to retain the ram in a fixed position, usually a retracted position, until power is applied to extend the ram. The lock is sequentially actuated to an unlocked state before the torque necessary to deploy the ram is applied. This is typically accomplished by a solenoid or electric motor mechanically linked to the lock mechanism and is separate from the drive motor that actuates the load. The use of a separate lock driver actuator increases the cost and complexity of the actuator. Separate dedicated actuation commands and logic devices are needed to control the lock and electrical wiring or hydraulic tubing may be required to transmit the commands to actuate the lock.

### BRIEF DESCRIPTION OF THE INVENTION

In one embodiment, a landing gear assembly for an aircraft includes a leg having a first end rotatably coupled to the aircraft for rotating between retracted and extended positions, a link assembly, and a drive screw assembly having a casing coupled to the aircraft and having an interior with an open end and having at least one detent, a piston slidably coupled to the casing for reciprocation relative to the casing and another portion mounted to the link assembly, a drive screw provided within the casing and extending into the piston, a nut assembly threadably coupled on the drive screw and having at least one moveable segment receivable within the detent and a cam operably coupled to the at least one moveable segment to move the segment into the detent, and the cam having a key, a screw cap rotationally mounting an end of the drive screw proximate the open end and having a keyway for receiving the key.

In another embodiment, a drive screw assembly includes a casing having one end for coupling to a structure and having an interior with an open end and having at least one detent, a piston slidably coupled to the casing for reciprocation relative to the casing, a drive screw provided within the casing and extending into the piston, a nut assembly threadably coupled on the drive screw and having at least one moveable segment receivable within the detent and a cam operably coupled to the at least one moveable segment to move them segment into the detent, and the cam having a key, and a screw cap rotationally mounting an end of the drive screw proximate the open end and having a keyway for receiving the key.

### BRIEF DESCRIPTION OF THE DRAWINGS

In the drawings:

FIG. 1 is a perspective view of a landing gear assembly according to an embodiment of the invention in an extended position.

FIG. 2 is a perspective view of the landing gear assembly of FIG. 1 in a retracted position.

FIG. 3 is a cross-sectional view of a drive screw assembly in a retracted state, which may be used in the landing gear of FIG. 1 according to an embodiment of the invention.

FIG. 4 is cross-sectional view of the drive screw assembly of FIG. 3 in an unlocked state.

FIGS. 5A-5D illustrate cross-sectional views of a portion of the drive screw assembly of FIG. 3 moving into the extended state.

FIG. 6 is a cross-sectional view of the drive screw assembly of FIG. 3 in an extended and locked state.

FIG. 7 is cross-sectional view of the drive screw assembly of FIG. 3 in a locked state.

FIG. 8 is a cross-sectional view of the drive screw assembly of FIG. 3 partially extended and in an unlocked state.

### DESCRIPTION OF EMBODIMENTS OF THE INVENTION

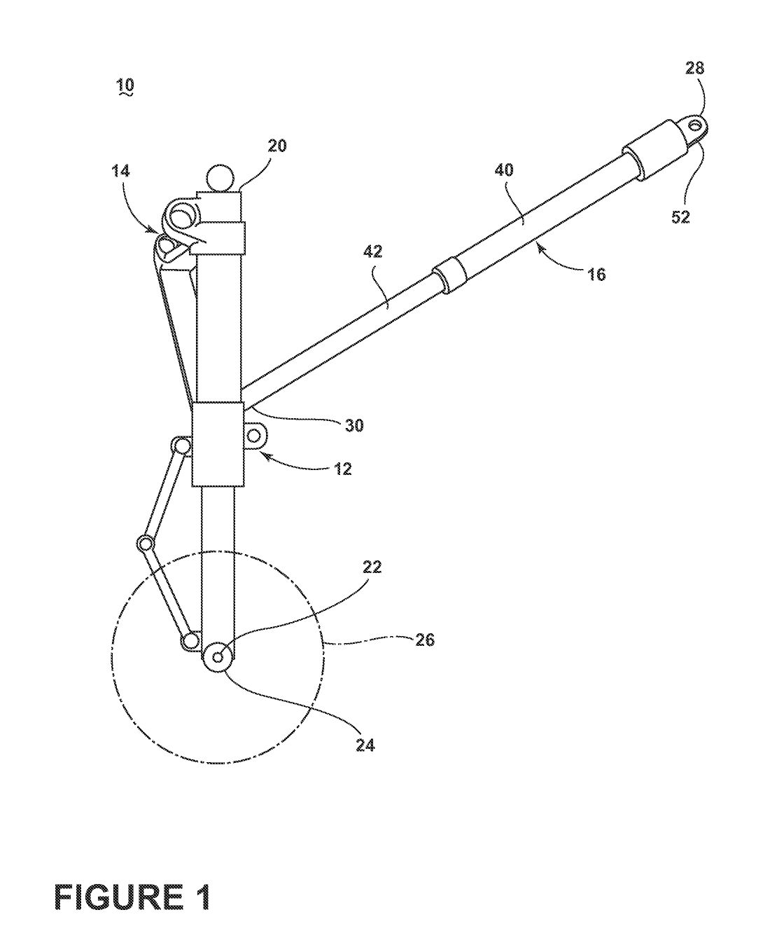

FIG. 1 illustrates a landing gear assembly 10 for an aircraft (not shown) according to an embodiment of the invention and including a leg 12, a link assembly 14, and an actuator in the form of a drive screw assembly 16. The leg 12 may have a first end 20 rotatably coupled to the aircraft for rotating between retracted and extended positions. The leg 12 may be mounted to the fuselage or the wings of the aircraft and in the retracted position the leg 12 may be accommodated within a landing gear bay within the fuselage or wings of the aircraft. For example, the aircraft may include a helicopter and in that case the leg 12 would be mounted to the fuselage of the aircraft.

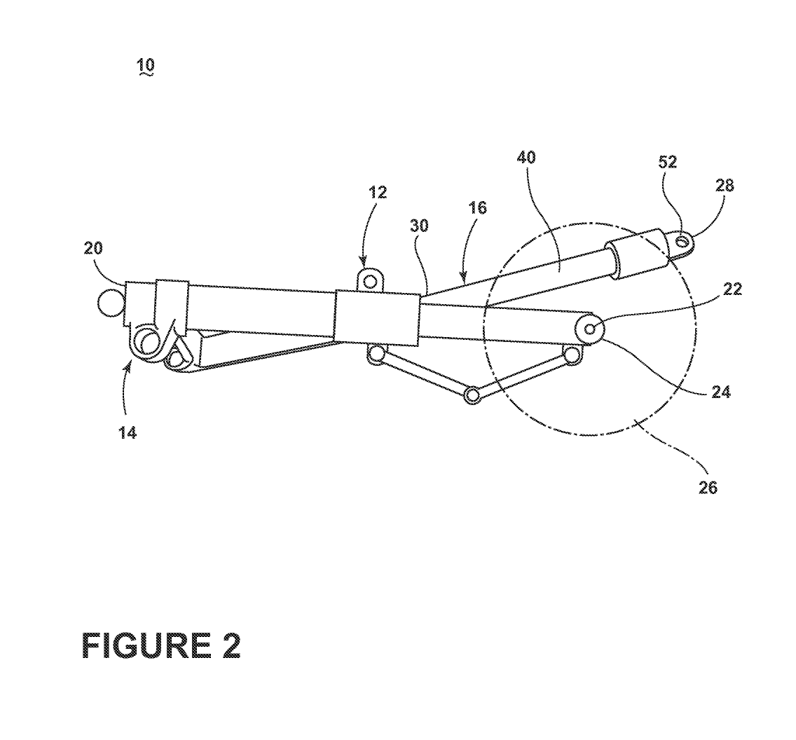

A wheel mount 22 may be included on the leg 12 proximate to a second end 24 of the leg 12 and a wheel 26 may be mounted thereon. The drive screw assembly 16 may be operably coupled at a fist end 28 to the aircraft and at a second end 30 to the link assembly 14. The link assembly 14 may include multiple rotatably coupled links, with one of the links rotatably coupled to the aircraft, including being coupled through the drive screw assembly 16, and another of the links rotatably coupled to the leg 12. Operation of the drive screw assembly 16 moves the link assembly 14 and the leg 12 between the extended position as shown in FIG. 1 and the retracted position shown in FIG. 2 and is capable of locking the landing gear assembly assembly 10.

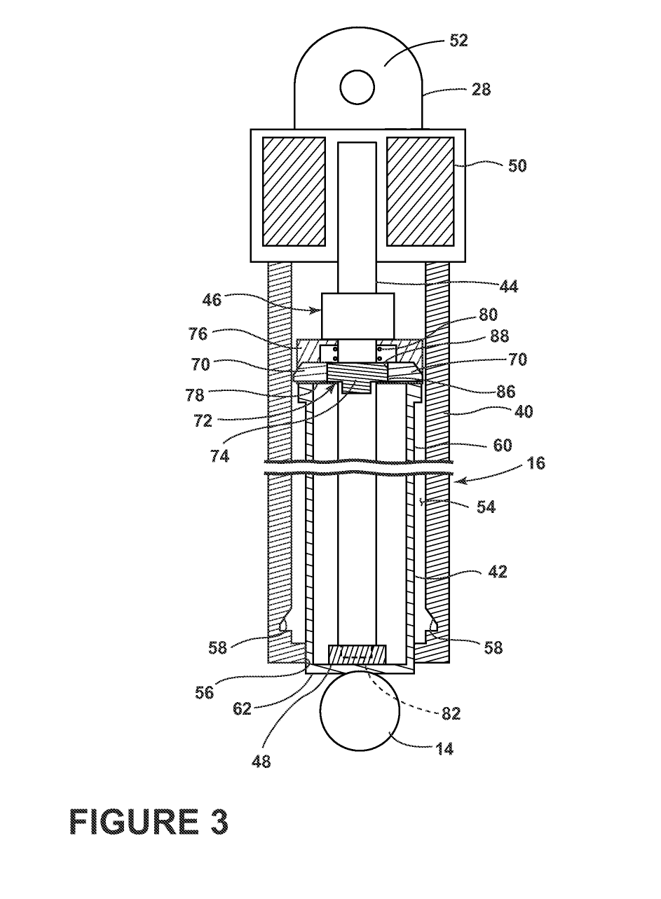

FIG. 3 more clearly illustrates that a casing 40, piston 42, drive screw 44, nut assembly 46, and screw cap 48 may be included in the drive screw assembly 16. Further, a motor assembly 50 may be located at the first end 28 and may be configured to rotate the drive screw 44. The motor assembly 50 may be any suitable type of motor assembly 50 including by way of non-limiting examples an electric, hydraulic or pneumatic motor assembly that may provide a rotary drive source for the drive screw 44.

In the illustrated embodiments, the casing 40 may include or be operably coupled with an end connector such as an eye end 52, which is the portion of drive screw assembly 16 coupled to the aircraft. The casing 40 may have an interior 54 with an open end 56 and may include at least one detent 58. More specifically, the at least one detent 58 may be located on an inner surface of the casing 40. Multiple detents 58 have been illustrated as being included in the casing 40. The casing 40 may be formed in any suitable manner and has been shown in the form of a cylinder for illustrative purposes.

The piston 42 may have at least a portion 60 received within the interior 54 and may be slidably coupled to the casing 40 for reciprocation relative to the casing 40. Another portion 62 may be mounted directly to the link assembly 14, which has been schematically illustrated as a circle, or may be operably coupled to the link assembly 14 through a mounting device (not shown). The drive screw 44 may be provided within the casing 40 and may extend into the piston 42. The nut assembly 46 may be threadably coupled on the drive screw 44. It is contemplated that the drive screw 44 and nut assembly 46 may be any suitable configuration that may translate rotary motion of the drive screw 44 into linear, axial displacement of the nut assembly 46. By way of non-limiting example, the drive screw 44 may include a ball screw shaft having external threads, which cooperate with a translating ball nut forming the nut assembly 46.

The nut assembly 46 is illustrated as including at least one moveable segment 70 receivable within the detent 58 and a cam 72 operably coupled to the at least one moveable segment 70 and having a key 74. Multiple moveable segments 70 have been illustrated and correspond with the multiple detents 58. The detents 58 and the moveable segments 70 may have complementary surfaces, which may be at an angle relative to a rotational axis of the drive screw.

A nut housing 76 and nut cap 78 may be included in the nut assembly 46 for retaining portions of the nut assembly 46 including a biasing element 80 that may bias the cam 72 axially along the drive screw 44 toward the screw cap 48. The cam 72 may be preloaded against the nut cap 78 by compression of the biasing element 80. The biasing element 80 may include any suitable biasing element 80 including a compression spring.

The screw cap 48 may rotationally mount an end of the drive screw 44 proximate the open end 56 of the casing 40. The screw cap 48 may include a keyway 82 for receiving the key 74. The key 74 and the keyway 82 may have complementary driving surfaces, which abut when the key 74 is received within the keyway 82.

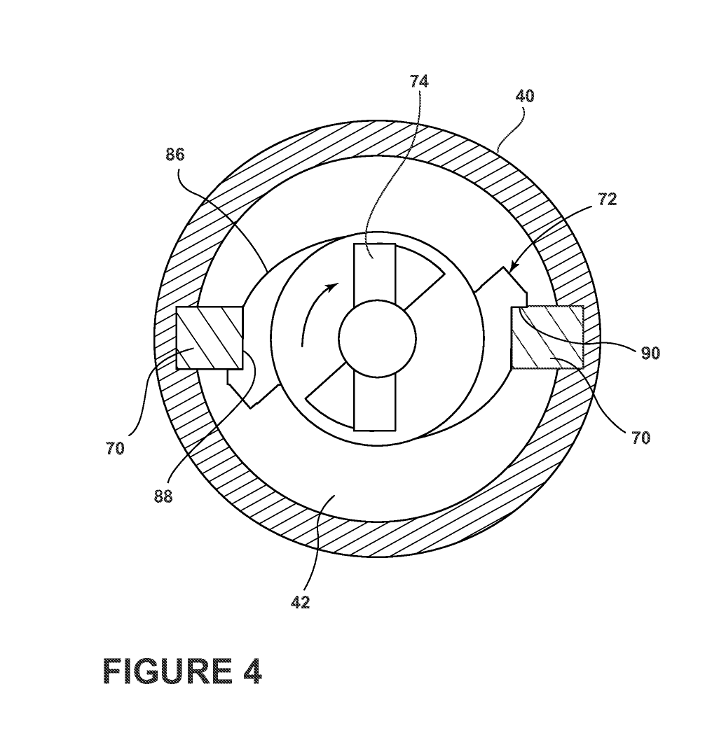

The components of the nut assembly 46 will now be described in more detail with respect to FIG. 4. The cam 72 may include a cam surface 86 abutting an end 88 of the moveable segment 70. The cam surface 86 may have an increasing radius such that rotation of the cam 72 radially extends the moveable segment 70. The cam surface 86 may terminate in a stop 90 that abuts the moveable segment 70 after a predetermined amount of rotation.

Initially, the operation will be described with respect to the drive screw assembly 16, and thus the landing gear assembly 10, being in the retracted position (FIG. 3). When it is desired to deploy the landing gear assembly 10 through operation of the drive screw assembly 16, the motor assembly 50 may be energized and drive torque may be applied to the rotatable drive screw 44. Rotation of the drive screw 44 results in the nut assembly 46 translating the piston 42. More specifically, the input torque is applied to the rotatable drive screw 44, which drives the nut assembly 46 and piston 42 forwardly, to extend the piston 42, which may be attached to the link assembly 14 of the leg 12. In this manner, rotation of the drive screw 44 is translated into linear, axial displacement of the nut assembly 46 and piston 42.

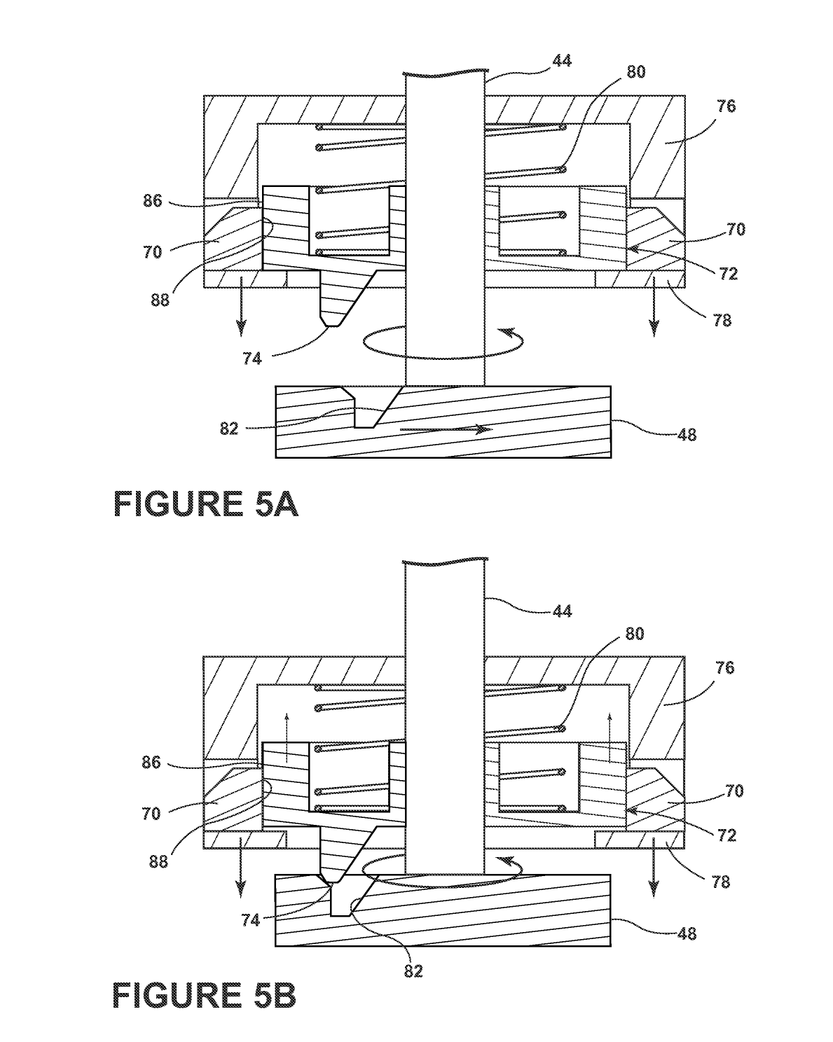

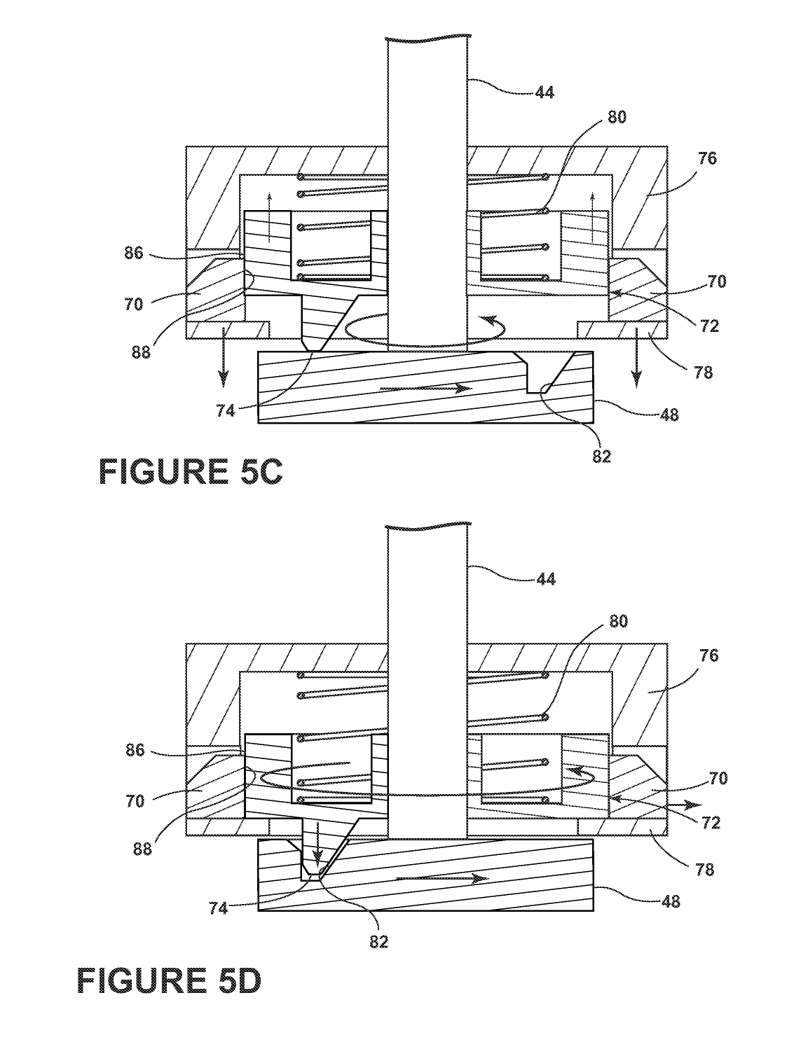

As the translation of the piston 42 is nearing its end, the nut assembly 46 traverses towards the screw cap 48 as more clearly shown in FIG. 5A. FIG. 5B illustrates that the key 74 may make initial contact with the screw cap 48. Both the key 74 and keyway 82 feature corresponding or complementary chamfers to allow the key 74 to pass over the keyway 82. This ensures that any partial engagement of the key 74 is avoided and removes dependency on the timing of the screw position with the location of the cam 72. The contact between the cam 72 and keyway 82 is taken up through compression of the biasing element 80.

FIG. 5C illustrates that further turning of the drive screw 44 and corresponding axial travel of the nut assembly 46 results in further compression of the biasing element 80. It is contemplated that the key 74 may include a flat bottom to enable the key 74 to run over the surface of the screw cap 48. Any friction force and resulting torque generated between the flat surface of the key 74 and screw cap 48 would be insufficient to drive the cam and engage lock. The biasing element 80 allows the cam 72 to ride over the keyway 82 of the screw cap 48 and ensures engagement of the key 74 into the keyway 82.

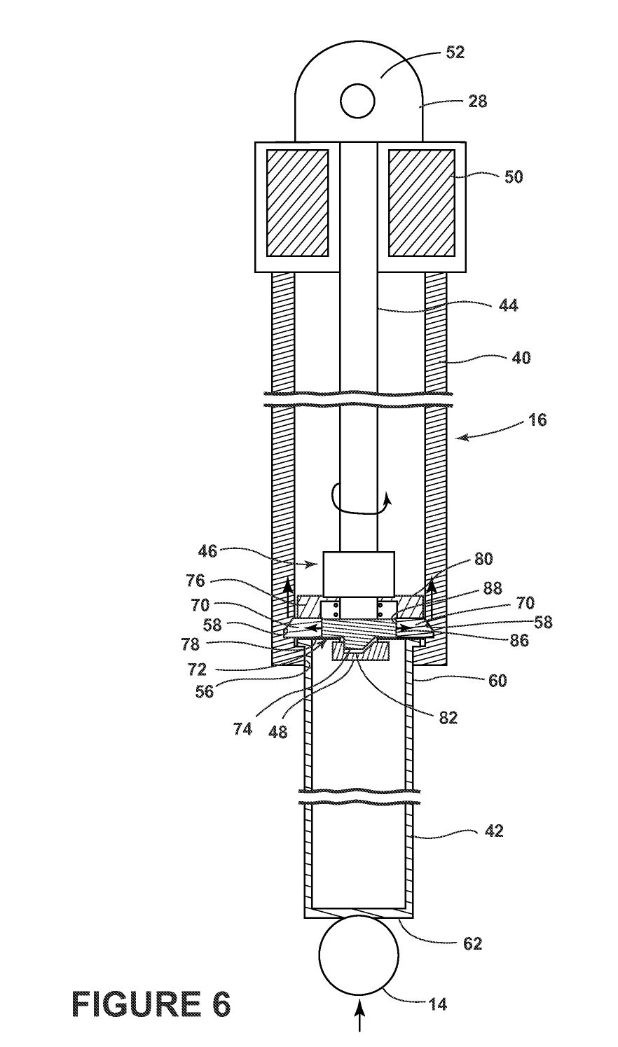

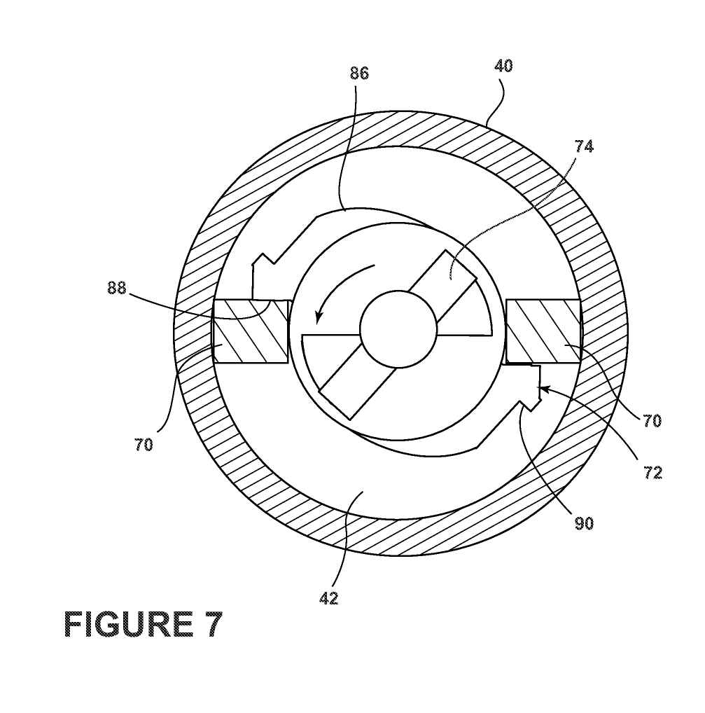

The biasing element 80 also provides a compressive force to enable the cam 72 to drive the moveable segments 70. More specifically, FIG. 5D illustrates that the increasingly spring loaded key 74 has engaged with the keyway 82 on the screw cap 48. At this point the translation of the piston 42 is complete and the moveable segments 70 are aligned with the detents 58 in casing 40. Once the cam 72 engages into the screw cap 48 fitting drive to the cam 72 is transferred on the driving surface of the key 74. It is this drive that rotates the cam 72 and drives the moveable segments 70 into lock position inside the detents 58 of the casing 40. More specifically, when the cam 72 rotates, the moveable segments 70 are pushed out by the increasing radius of the cam surface 86 and the moveable segments 70 extend into the casing 40. This locks the piston 42 relative to the casing 40 to fix the leg 12 in the extended position. Once the cam 72 reaches its final position, the motor assembly 50 is turned off. The drive screw assembly 16 is illustrated in an extended and locked state in FIG. 6. The landing gear assembly 10 is able to take the force of high loads and such loads are born by the casing 40 and piston 42 and not the drive screw 44.

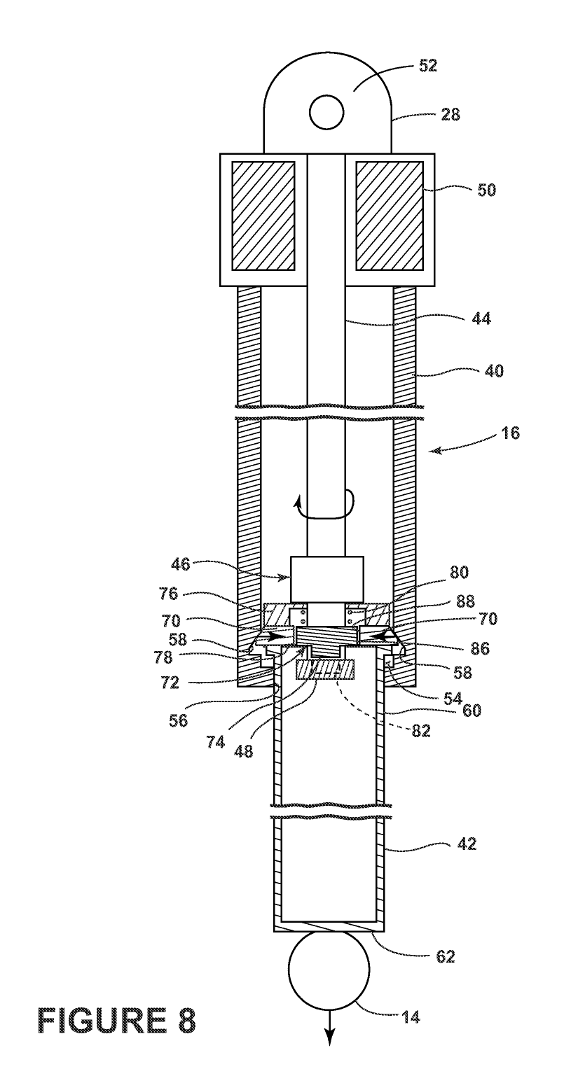

To unlock the drive screw assembly 16, the aircraft lifts off and a tension load is applied by the weight of the landing gear assembly 10 and unloads the lock of the drive screw assembly 16. The cam 72 is unlocked using contact between the ramped face of the key 74 and keyway 82. More specifically, a combination of compressive and reactive force provided by the biasing element 80 and complementary driving surfaces are used to transmit torque. In this manner, the drive screw 44 rotates in an opposite direction causing the cam 72 to rotate and unlock the moveable segments 70. The complementary driving surfaces are between 45 and 70 degrees, as the angle increases, so does the dependency on static friction to transmit torque. The moveable segments 70 retract due to piston load acting on ramp angle of the moveable segment 70, as illustrated in FIG. 8.

The above described embodiments provided a variety of benefits including those of a self-locking and unlocking assembly that preclude the need for a separate mechanical or electrical command or device to unlock or relock the actuator during normal operation. This reduces the weight of the actuator assembly and reduces the envelope requirement for both length and diameter as compared to conventional locking actuators that require a separate command to unlock the lock element. Both the reduction in weight and reduction in size may provide operational advantages. The above described embodiments have few moving parts and the rotary arrangement ensures a large lock contact area and low contact pressures. The self-locking assembly may provide these benefits in any suitable environment including that of the landing gear as described above.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A landing gear assembly for an aircraft comprising:
a leg having a first end rotatably coupled to the aircraft for rotating between retracted and extended positions;
a link assembly comprising multiple rotatably coupled links, with one of the links rotatably coupled to the aircraft and another of the links rotatably coupled to the leg; and
a drive screw assembly comprising:
a casing coupled to the aircraft and having an interior with an open end and having at least one detent;
a piston having at least a portion received within the interior and slidably coupled to the casing for reciprocation relative to the casing and another portion mounted to the link assembly;
a drive screw provided within the casing and extending into the piston;
a nut assembly threadably coupled on the drive screw and having at least one moveable segment receivable within the detent and a cam operably coupled to the at least one moveable segment to move the segment into the detent, and the cam having a key; and
a screw cap rotationally mounting an end of the drive screw proximate the open end and having a keyway for receiving the key;
wherein upon the rotation of the drive screw, the nut assembly traverses the drive screw where it contacts the piston to move the leg from the retracted position to the extended position and when the key engages the keyway, the cam moves the moveable segment into the detent, which locks the piston relative to the casing to fix the leg in the extended position.

2. The landing gear assembly of claim 1 wherein the nut assembly further comprises a biasing element biasing the cam axially along the drive screw toward the screw cap.

3. The landing gear assembly of claim 1 wherein the cam comprises a cam surface abutting an end of the moveable segment.

4. The landing gear assembly of claim 3 wherein the cam surface has an increasing radius such that rotation of the cam radially extends the moveable segment.

5. The landing gear assembly of claim 4 wherein the cam surface terminates in a stop that abuts the moveable segment after a predetermined amount of rotation.

6. The landing gear assembly of claim 1 wherein the detent and the moveable segment have complementary surfaces.

7. The landing gear assembly of claim 6 wherein the complementary surfaces are at an angle relative to a rotational axis of the drive screw.

8. The landing gear assembly of claim 1 wherein the key and the keyway have complementary chamfers preventing immediate locking of the key in the keyway upon initial contact between the key and the keyway.

9. The landing gear assembly of claim 8 wherein the nut assembly further comprises a biasing element biasing the cam axially along the drive screw toward the screw cap.

10. The landing gear assembly of claim 8 wherein the key and the keyway have complementary driving surfaces, which abut when the key is received within the keyway.

11. The landing gear assembly of claim 10 wherein the complementary driving surfaces are between 45 and 70 degrees.

12. A drive screw assembly comprising:
a casing having one end for coupling to a structure and having an interior with an open end and having at least one detent;
a piston having at least a portion received within the interior and slidably coupled to the casing for reciprocation relative to the casing and another portion for coupling to a moveable portion;
a drive screw provided within the casing and extending into the piston;
a nut assembly threadably coupled on the drive screw and having at least one moveable segment receivable within the detent and a cam operably coupled to the at least one moveable segment to move the at least one moveable segment into the detent, and the cam having a key; and
a screw cap rotationally mounting an end of the drive screw proximate the open end and having a keyway for receiving the key;
wherein upon rotation of the drive screw, the nut assembly traverses the drive screw to move the piston out of the casing ultimately causing the key to engage the keyway, which causes the cam to move the moveable segment into the detent, which locks the piston relative to the casing.

13. The drive screw assembly of claim 12 wherein the cam comprises a cam surface abutting an end of the moveable segment.

14. The drive screw assembly of claim 13 wherein the cam surface has an increasing radius such that rotation of the cam radially extends the moveable segment.

15. The drive screw assembly of claim 14 wherein the cam surface terminates in a stop that abuts the moveable segment after a predetermined amount of rotation.

16. The drive screw assembly of claim 12 wherein the detent and the moveable segment have complementary surfaces.

17. The drive screw assembly of claim 12 wherein the key and the keyway have complementary chamfers preventing immediate locking of the key in the keyway upon initial contact between the key and the keyway.

18. The drive screw assembly of claim 17 wherein the nut assembly further comprises a biasing element biasing the cam axially along the drive screw toward the screw cap.

19. The drive screw assembly of claim 17 wherein the key and the keyway have complementary driving surfaces, which abut when the key is received within the keyway.

20. The drive screw assembly of claim 19 wherein the complementary surfaces are between 45 and 70 degrees.
